(19) United States
(12) Patent Application Publication
(10) Pub. No.: US 2026/0295852 A1
(43) Pub. Date: Oct. 1, 2026

(54) CHAINING OF TIRES BY ROBOTIC MEANS USING THREE-DIMENSIONAL VIEWING

(71) Applicant: COMPAGNIE GENERALE DES ETABLISSEMENTS MICHELIN, Clermont-Ferrand (FR)

(72) Inventors: PIERRE BOUGES, Clermont-Ferrand (FR); NICOLAS BARD, Clermont-Ferrand (FR); MOHAMED-ABBAS KONATE, Clermont-Ferrand (FR); FABRICE DA-COSTA, Clermont-Ferrand (FR)

(21) Appl. No.: 19/482,243

(22) PCT Filed: Apr. 25, 2024
(86) PCT No.: PCT/EP2024/061352

§ 371 Date: Nov. 7, 2025

(30) Foreign Application Priority Data
May 11, 2023 (FR) FR2304654

(51) Int. Cl. B25J 9/16; B65G 1/18; B65G 57/22; G06T 1/00; G06V 10/26; G06V 10/764; G06V 10/82; G06V 20/50; G06V 20/64

(52) U.S. Cl. CPC B25J 9/1697; B65G 1/18; B65G 57/22; G06T 1/0014; G06V 10/26; G06V 10/764; G06V 10/82; G06V 20/50; G06V 20/64; B65G 2201/0273

(57) ABSTRACT

The method for automatically lacing tires from a group of tires in an unknown arrangement and for which a predetermined target location must be achieved is implemented by at least one processor comprising an image processing module that uses a positioning algorithm to select the optimal location of a target tire to be laced. A system for automatically lacing tires comprises at least one picking device, a detection system for collecting the information concerning the physical environment around each picking device, and a communication network comprising at least one communication server for executing programmed instructions stored in a memory of one or more processors of the lacing system that uses a positioning algorithm in order to implement the disclosed lacing method.

### TECHNICAL FIELD

The invention relates to a system that implements a method for lacing tyres from a group of tyres in an unknown arrangement. More specifically, the invention relates to an automatic system adapted to lace the tyres in any target location, irrespective of the parameters of the target location and the variable parameters of various tyres being arranged.

### CONTEXT

In the field of tyre lacing, tyre arrangements exist that make the tyres easier to handle and that allow them to be optimally stored in the available storage space. With reference to FIG. 1, one embodiment for storing tyres is shown in which several layers of tyres 10 partially overlap one another. With this type of tyre storage (known in the field as a “rick-rack” arrangement), the tyres are stacked (or “laced”) in a container 12, with the overlapping direction being reversed from one layer to the next depending on the lacing process. In this configuration, the space between lateral parts 12a of the container 12 is optimally used. The container 12 can be selected from among the known containers for transporting tyres, including, but not limited to, pallets, open-bodies of trucks, chain-bound beds of trucks, box-bodies of trucks or vans and equivalents thereof. The structure of this stacking pattern is described in detail in patent DE2426471A1.

Other types of tyre storage are also known for transporting such tyres in containers. In one tyre storage embodiment known as “roll storage”, the tyres are stored next to one another on their tread along a common horizontal axis. In one tyre storage embodiment known as “stacked storage”, the tyres are stacked next to one another on their sidewalls along a common vertical axis.

Automated solutions exist for lacing the tyres in containers according to the selected type of storage. These solutions incorporate vision-based control of a robot in the context of grasping tyres by gripping. Examples are provided in patent U.S. Pat. No. 8,244,400 (which discloses a device for the automated lacing of tyres on a support that comprises a handling device with one or more gripping tools coupled for receiving and setting down the tyres), patent U.S. Pat. No. 8,538,579 (which discloses a depalletisation system for implementing a method for depalletising tyres set down on a support, the system being guided by a robot with a gripping tool), and patent U.S. Pat. No. 9,440,349 (which discloses an automatic loader/unloader of tyres for stacking them on/unstacking them from a trailer, comprising an industrial robot capable of a selective articulated movement).

Lacing technologies often use a combination of a laser scan of the surface assumed to contain the objects to be picked up and knowledge of the object being sought (CAD). The system seeks to superpose the elements measured in the actual space with the elements known from the CAD in order to precisely find the object and its spatial configuration in order to then be capable of grasping it in the manner that is consistent with the design of the gripper. The majority of the methods used in industry thus work by attempting to control the environment. From a hardware standpoint, this can be achieved by requiring facilities that are highly specialised for the task, either by learning references in the fixed working environment, or by attempting to realign a CAD model in a scene of the point cloud type in order to detect an object.

A method requiring a specific physical facility, however sophisticated it might be, will no longer work if there are significant variations in the facility. A model realignment requires all the objects in the container to be identical (to within a scaling factor) and to be largely visible in order to achieve suitable matching. For example, patent U.S. Pat. No. 8,538,579 proposes using the CAD data of the tyres to perform the “storage densification” work. This requires either a completely uniform pallet of identical tyres, the dimension of which is captured once and then the system processes them automatically, or that the tyre reference be read on a case-by-case basis, its dimensions looked up in a CAD database, computation of its optimal storage position, and then the handling of the tyre.

In addition, there are storage means specific to the tyres other than product recognition. For example, patent EP 2062824 B1 discloses individual boxes that facilitate the transport of cylindrical articles such as tyres. In particular, a folded box is disclosed that allows the tyres to be handled and stored in a stable manner. As a result, the storage of the boxes themselves leads to a significant loss of space and high costs.

The tasks of filling and emptying known containers for transporting tyres (and in particular, trucks) are by definition uncertain: the sequence of the laced tyres is not known in advance, and neither is their dimension; accessibility is poor, and accessibility for gripping is likewise poor; and the tyres can be only partially seen. Controlling the environment is not therefore viable.

Thus, the disclosed invention allows a link to be established between lacing processes and the management of lacing tyres arranged in a group of tyres arranged without prior knowledge of their precise configuration.

### SUMMARY OF THE INVENTION

The invention relates to a method for automatically lacing tyres from a group of tyres in an unknown arrangement and intended for lacing in a predetermined target location, the lacing method being implemented by at least one processor comprising an image processing module that uses a positioning algorithm to select the optimal location of a target tyre to be laced, characterised in that the lacing method comprises the following steps:
a step of providing a lacing system including the processor, wherein the lacing system comprises at least one picking device that picks up a target tyre from the group of tyres;
a step of estimating the dimensions of a target location intended for the tyres of the group of tyres for lacing, with this step comprising a step of scanning the target location in order to determine its parameters;
a step of creating the origin of a location-device reference, during which step the lacing system creates a reference in order to determine the positioning coordinates of a first tyre in the target location;
a step of estimating the dimensions of a target tyre to be laced in the target location, during which step the device identifies the first tyre to be taken from the group of tyres;
a positioning step for positioning each tyre to be laced, with this step comprising the following steps:
   a step of performing a tyre positioning process that is performed for each tyre to be laced;
a step of approaching the device towards the identified target tyre; and
a step of picking up the identified target tyre;
a step of scanning the tyre after it is positioned during the positioning step; and
a final step of updating the position of the tyre, during which step the actual position of the last positioned tyre, estimated during the step of scanning the positioned tyre, includes the 2D centre of the positioned tyre and its orientation, thereby updating the positioning algorithm of the actual position of the last positioned tyre,
   such that the update allows the estimated actual position to be checked to determine that it is consistent with the physical boundaries of the target location; and
   such that the lacing of the tyres is achieved when the picking device releases the tyre.

In some embodiments of the lacing method of the invention, during the step of performing a positioning process for each tyre to be laced:
the group of tyres is modelled in a two-dimensional (2D) space in the form of a rectangle, wherein the width and the height of the rectangle are equal to the width and the height of the inside of the target location; and
each tyre of the group of tyres is modelled using a rectangle, the width and the height of which are equal to the width and the diameter of the depicted tyre.

In some embodiments of the lacing method of the invention, the step of estimating the dimensions of a target tyre to be laced comprises a few-shot learning process comprising the following steps:
a step of acquiring data corresponding to the arranged tyres, during which step a detection system of the picking device captures an initial image of the randomly arranged tyres;
a step of feeding an extraction neural network and an attention neural network, during which step both neural networks are trained by taking a plurality of sample images obtained during the data acquisition step as training data and a plurality of classifications of objects of images as data labels;
a step of performing a three-dimensional (3D) reconstruction process wholly performed based on the data from the extraction neural network and the attention neural network, during which step coordinates corresponding to the location of an identified target tyre and its orientation are reconstructed from this data, such that this reconstruction can be used to provide the geometric information required to generate an ideal pick-up point on the identified target tyre;
a step of approaching the device towards the identified target tyre, during which step the attention neural network sends the coordinates corresponding to the location of the identified target tyre and its orientation to the picking device; and
a step of extracting the identified target tyre from the tyre arrangement in order to place it in the target location.

In some embodiments of the lacing method of the invention, the step of feeding the extraction neural network and the attention neural network comprises the following steps:
a step of training the extraction neural network to segment a scene viewed by the detection system of the management system; and
a step of constructing the attention mechanism, during which step the attention neural network extracts differentiated features from among various categories in a target tyre detection model, such that the model is guided in order to locate key areas in a segmented image;
   wherein the step of training the extraction neural network comprises a step of segmenting data based on a plurality of cycles of a repetitive movement of the picking device during one or more lacing cycles.

In some embodiments of the lacing method of the invention, during the step of performing the 3D reconstruction process, the orientation, the dimensions and the location of the identified target tyre are reconstructed from the data from the extraction neural network and the attention neural network.

In some embodiments of the lacing method of the invention:
the step of acquiring data from the few-shot learning process comprises a step of constructing a point cloud from RGB-D images; and
the approach step of the picking device comprises a step of picking up the identified target tyre at the ideal pick-up point computed during the step of performing the 3D reconstruction process.

In some embodiments of the lacing method of the invention, the tyre positioning process comprises the following steps:
a step of positioning the first tyre that can be picked up from the group of tyres where this first tyre is positioned flat in a location corresponding to the selection of the location-device reference created during the step of creating the origin of the reference; and
a step of storing tyres from the second tyre, during which step the positioning algorithm uses a concept of rows that is a series of tyres positioned in the same direction, and wherein each type of row is associated with an orientation set to be tested for the tyre to be positioned.

In some embodiments of the lacing method of the invention, during the step of storing tyres, the positioning algorithm applies the following steps in order to select the candidate positions of the tyre:
a step of initially computing all the positions that bring the relevant tyre into contact with the boundaries of the target location;
a step of subsequently computing all the positions that bring the tyre into contact with the already laced tyres;
a step of retaining, from among all the positions computed during the previous step, positions allowing the tyre to have at least two contact points with the boundaries of the group of tyres or with the other tyres; and
a final step of retaining positions for completing the current row that represents the only position for completing the current row.

In some embodiments of the lacing method of the invention, the step of storing tyres further comprises:
a step of computing a stability and lacing criterion for determining whether the position of the tyre is stable at each position retained following the selection of the candidate positions of the tyre; and
a conversion step, during which step the 2D centre derived from the positioning algorithm is converted towards the 3D centre of the tyre in the target location; such that the positioning algorithm indicates the centre of the tyre in the rear plane of the group of tyres, as well as its orientation to position the tyre in the target location so as to obtain the 3D centre of the tyre and couple it with the orientation.

In some embodiments of the lacing method of the invention, during the step of computing a stability and lacing criterion:
the stability of the position of the new tyre depends on the vertical starting from its centre of gravity and the bearing area of the new tyre; and
the lacing criterion is based on a horizontal signed distance between the centre of the last placed tyre and the end of the new tyre.

In some embodiments of the lacing method of the invention, during the step of scanning the tyre performed during the positioning step:
the lacing system scans an area where the last tyre has been positioned; and
an attention mechanism is then used to detect the last positioned tyre.

The invention also relates to a system for automatically lacing tyres from a group of tyres in an unknown arrangement and for which a predetermined target location must be achieved, characterised in that the lacing system comprises:
at least one picking device comprising a robot having a peripheral gripping component supported by a pivotable elongate arm and extending from the elongate arm to a free end, at which a gripper is arranged along a common longitudinal axis;
a detection system for collecting the information concerning the physical environment around each picking device, the detection system comprising one or more sensors configured to detect two-dimensional (2D) and/or three-dimensional (3D) images; and
a communication network that manages the data entering the lacing system from at least one picking device, the communication network comprising at least one communication server that allows programmed instructions to be executed that are stored in a memory of one or more processors of the lacing system that uses a positioning algorithm in order to implement the disclosed lacing method;
   such that each cleaning device is configured on one or more parameters of at least one identified tyre computed by an image processing module incorporated into the memory of the processor in order to set the cleaning device in motion so that the peripheral gripping component can pick up a target tyre during the lacing method performed by the lacing system.

In some embodiments of the lacing system of the invention, the detection system comprises at least one RGB-D camera fixed to at least one element from among the peripheral gripping component, the elongate arm and the gripper of the cleaning device.

In some embodiments of the lacing method of the invention, the predetermined target location comprises at least one location selected from one or more containers, one or more trucks, one or more trailers, one or more warehouses, one or more distribution centres, one or more conveyors, one or more pallets, and one or more storage means.

Further aspects of the invention will become apparent from the following detailed description.

### BRIEF DESCRIPTION OF THE DRAWINGS

The nature and the various advantages of the invention will become more apparent from reading the following detailed description, and with reference to the appended drawings, in which the same reference signs throughout denote parts that are identical, and in which:

FIG. 1 shows a perspective view of one embodiment of tyre storage;

FIGS. 2 and 3 show constituent parts of a known tyre in a meridian plane;

FIG. 4 shows a partial perspective view of an embodiment of a picking device used in a lacing system of the invention;

FIG. 5 shows an example of a group of arranged tyres being processed by a picking device of the type shown in FIG. 4;

FIG. 6 shows a flow diagram of an embodiment of a lacing method of the invention performed by the lacing system;

FIG. 7 shows an example of a trailer that is used as a target location when tyres are laced during the lacing method of the invention;

FIG. 8 shows an example of a first grippable tyre that is identified for positioning in a target location during the lacing method of the invention;

FIG. 9 shows a tyre positioning process performed during a positioning step of the lacing method of the invention;

FIG. 10 shows a schematic view of the types of positioning directions of the tyres achieved during the positioning process;

FIG. 11 shows a schematic view of an orientation set to be tested for the tyre to be positioned during a step of storing tyres of the positioning process;

FIG. 12 shows an example of the implementation of tyre storage in a target location;

FIGS. 13 and 14 respectively show a stable position and an unstable position representing the stability of the position of a tyre positioned during the positioning process;

FIGS. 15 and 16 show an illustration of a lacing criterion used during the positioning process;

FIG. 17 shows a schematic view of a conversion step performed during the positioning process;

FIGS. 18 and 19 respectively show schematic views of an actual position of the last positioned tyre and the updating of this actual position during the positioning process.

### DETAILED DESCRIPTION

When considering the type of tyre storage that best uses the available storage space, the geometry of the tyres that are being transported must be considered. FIGS. 2 and 3 show schematic diagrams of a tyre P, which conventionally comprises two circumferential beads intended to allow the tyre to be hooked onto a rim. Each bead comprises an annular reinforcing bead wire. The make-up of a tyre is typically described by a representation of its constituent parts in a meridian plane, i.e., a plane containing the axis of rotation of the tyre.

The radial, axial and circumferential directions respectively denote the directions perpendicular to the axis of rotation of the tyre, parallel to the axis of rotation of the tyre, and perpendicular to any meridian plane. The expressions “radially”, “axially” and “circumferentially” respectively mean “in a radial direction”, “in the axial direction” and “in a circumferential direction” of the tyre. The expressions “radially inner/inside” and “radially outer/outside” respectively mean closer to and further away from the axis of rotation of the tyre, in a radial direction.

With reference to FIG. 2, the tyre P comprises an inner boundary F_{I} and an outer boundary F_{E}, which together define the boundaries of a sidewall F of the tyre P. The inner boundary F_{I} separates the sidewall F of the tyre from a rim (not shown) on which the tyre is intended to be fitted. The tyre P also comprises a rim radius R_{J} defined as being the distance between a central point C of the tyre and the inner boundary F_{I} that separates the rim and the sidewall F of the tyre. The tyre P also comprises a sidewall inner diameter defined as being twice the rim radius R_{J}. The tyre P also comprises a tyre radius R_{P} defined as being the distance between the central point C and an outer boundary F_{E} of the sidewall F that represents the tread surface of the tyre. The tyre P also comprises a tyre diameter defined as being twice the tyre radius R_{P}.

With reference to FIG. 3, the inflated and unladen tyre P has several parameters relating to its geometry, including a nominal section width L_{P} and a height H_{P} (with the height H_{P} often being expressed as a percentage of the width L_{P}). The tyre P also has a measurement D_{J} that represents the diameter of a rim on which the tyre is intended to be fitted (with this measurement being substantially equal to the sidewall inner diameter F_{I}). It will be understood that each of these parameters can be expressed in equivalent known length measurements (for example, in millimetres (mm) or in inches (in)).

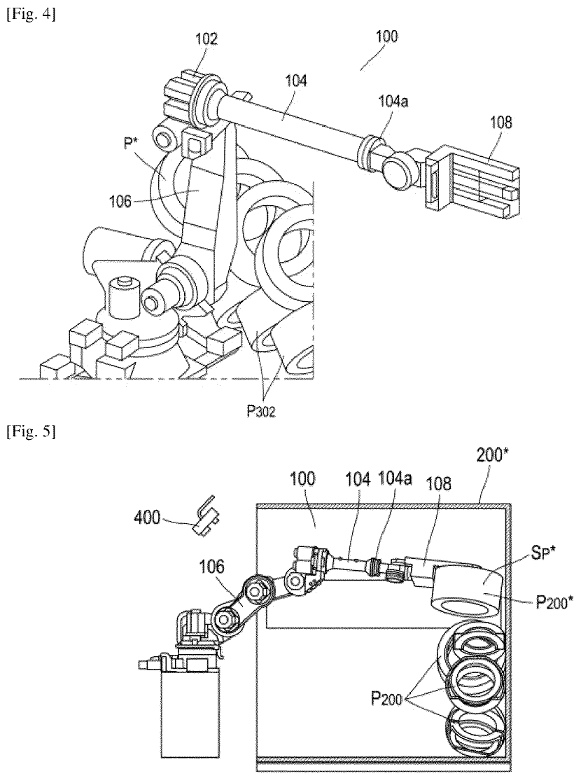

Reference will now be made to FIGS. 4 to 5, in which the same reference signs denote identical elements, FIGS. 4 and 5 show an embodiment of a picking device (or “device”) 100 that picks up a target tyre from an unknown tyre arrangement and for which a target location must be achieved during a lacing cycle of the invention. The device 100 forms part of a tyre lacing system (or “lacing system” or “system”) of the invention.

The term “lacing” is understood to include the functions of storing and removing arranged (or “laced”) tyres, as well as the target arrangement (including loading and unloading) of the tyres. It is understood that the term “target tyre” (in the singular or the plural) is used herein to refer to a tyre that is present in the physical environment of the device 100 and that is identified for positioning during a lacing cycle. It is understood that the term “target location” (in the singular or the plural) denotes a dedicated space where the tyres will be arranged (for example, a trailer, a belt, a conveyor, a container, a rack, etc.). The term “target arrangement” (in the singular or the plural) denotes a desired arrangement for the tyres arranged in a target location (for example, in a “rick-rack” or “laced” manner, “stored in rolls” or “stored in stacks”).

The system of the invention implements a lacing movement method (or “lacing method”) for the device 100 that incorporates a combination of vision techniques to correctly and quickly reconstruct the observed scene based on three-dimensional (or 3D) scattered point clouds originating from a segmented view of the target tyres.

The device 100 can be used in the spaces where tyres are arranged in an unknown manner and in the spaces where their target arrangement must be achieved. By way of an example, the device 100 can be used in relation to a container 200 containing tyres P₂₀₀. The device 100 can grip the tyres P₂₀₀ arranged in the container 200 in order to lace them in one or more target locations (for example, in a trailer 300, as shown in FIG. 7). It will be understood that any type of appropriate receptacle could be used instead of the container 200.

The device 100 therefore produces a target tyre arrangement in a predetermined target location. It will be understood that the device 100 can operate in several physical environments without prior knowledge of the parameters of such environments (for example, an initial or target arrangement of the tyres in a truck, in a warehouse, in a distribution centre, on a conveyor, on a pallet or with respect to other known storage and/or transport means).

With further reference to FIGS. 4 and 5, in one embodiment of the device 100, the picking device comprises a robot of the type disclosed by publication WO 2022/135968 of the Applicant. The robot has a peripheral gripping component 104 supported by a pivotable elongate arm 106. The peripheral gripping component 104 extends from the elongate arm 106 to a free end 104a where a gripper 108 is disposed along a common longitudinal axis. The robot is set in motion so that the gripper 108 can pick up a target tyre identified using the device 100 during a lacing method implemented by the system of the invention (as described below).

It is understood that the precise configuration of the device 100 shown in FIGS. 4 and 5 is provided by way of an example. For example, the device 100 could be provided with multiple types of grippers according to the features of a group of tyres to be laced. In another example, the device 100 can comprise a fixed robot installed in a lacing facility, and attached, for example, to a support from which the robot extends. In this case, it is understood that the robot can be attached to a ceiling, a wall, a floor or any support that allows the lacing method of the invention to be implemented. It is understood that the device 100 can comprise at least one roaming robot. “Roaming” is understood to mean that the picking device can be set in motion either by integrated movement means (for example, one or more integrated motors) or by non-integrated movement means (for example, one or more movable means including autonomous movable means). It is understood that the picking device can be a conventional industrial robot or a collaborative robot or even a delta or cable robot.

The device 100 also comprises a detection system (not shown) for gathering information relating to the physical environment around the device. The detection system comprises one or more sensors (including one or more cameras) configured for detecting two-dimensional (2D) and/or three-dimensional (3D) images, for 3D depth detection, and/or for other types of detection of the physical environment around the picking device (it is understood that the terms “sensor” and “camera” are used interchangeably). In the embodiments of the device 100 of the type shown in FIGS. 4 and 5, the one or more sensors of the detection system are attached to at least one from among the peripheral gripping component 104, the elongate arm 106 and the gripper 108 of the robot. In some embodiments of the system of the invention, these sensors could form part of an overall detection system that uses these sensors together with one or more sensors positioned in the physical environment in which the device 100 operates (for example, one or more cameras 400) (see FIG. 5).

In one embodiment of the device 100, the detection system comprises at least one camera that provides 3D images shown as a set of 3D points with coordinates X, Y, Z, and red, green, blue colour values (the “RGB” or “RGB-D” format) (known as “an RGB-D type camera”). In this embodiment, an RGB-D type camera is attached to at least one from among the peripheral gripping component 104, the elongate arm 106 and the gripper 108 of the device 100. Two or more RGB-D cameras can be oriented so that a predetermined overlap is obtained between the fields of view of the cameras. As used herein, the term “camera” includes one or more cameras.

RGB-D cameras generally provide depth information using depth maps, which are images in which each pixel contains the distance between the camera and the corresponding point in space. Compared to conventional measurement methods, such as manual measurement and other measurements based on electronic devices, 3D point cloud data originating from RGB-D cameras have a much higher measurement rate. Using a sparser structure, a point cloud can be constructed from RGB-D images by computing the real world (for example, the X, Y, Z coordinates) with the intrinsic data of a digital camera. Information relating to the physical environment around the device 100 is thus obtained from the 3D point cloud data obtained using detection technologies that are capable of accurately and efficiently capturing the 3D surface geometries of the target tyres.

The term “point cloud” (in the singular or the plural) is used herein to refer to one or more collections of data points in space. One or more cameras (or one or more equivalent devices) gather three-dimensional (3D) data and detect the surfaces of the objects (for example, of the arranged tyres) by virtue of a series of coordinates. Storing the information in the form of a collection of spatial coordinates can allow space to be saved, since many objects do not fill a large part of the environment. Even if the information is not visual, interpreting the data as a point cloud helps to understand the relationship between a plurality of variables by means of classification and segmentation.

It is understood that one or more cameras can include one or more programming modes, including a learning mode, in order to supply, modify and train at least one neural network.

Although the embodiments are described herein with regard to the use of one or more neural networks (for example, convolutional neural networks (CNNs)) as the machine learning model, other types of machine learning models can be used. These include, but are not limited to, models using linear regression, logistic regression, decision trees, support vector machines, naive Bayes, K-nearest neighbour (KNN), with K signifying a grouping, random forest, dimensionality reduction algorithms, gradient algorithms, neural networks (for example, autoencoding networks, CNNs, RNNs, perceptrons, logarithmic short-term memory (LSTM), Hopfield, Boltzmann, deep belief networks, deconvolution, generative adversarial networks (GANs), etc.) and complements and equivalents thereof. The one or more CNNs can be formed using ground-truth data generated using sensor data representing the movement of the device 100, including the positioning of the gripper 108.

The detection system of the device 100 detects the presence of a group of tyres in the field of view of the detection system (for example, the field of view of a camera of the device 100), which triggers it to capture the image of a target tyre (see, for example, the target tyre P_{200*} shown in FIG. 5). In all the embodiments of the device 100, the system “searches” the image obtained by the detection system for the presence of a tyre in the environment around the device 100. If no tyre is detected, the detection system continues to obtain the images until the search of the environment around the device 100 is exhausted.

The detection system can determine the information relating to the physical environment that can be used by a control system (which, for example, comprises software for planning the movements of the device 100). The control system could be located on the device 100 or it could communicate remotely with the device. In some embodiments of the device, one or more 2D or 3D sensors mounted on the device 100 (including, non-limitingly, navigation sensors) can be integrated in order to form a digital model of the physical environment (including, where applicable, the side or sides, the floor and the ceiling). Using the obtained data, the control system can cause the device 100 to move in order to navigate between the target tyre picking positions.

In order to properly manage the handling of the device 100 to ensure that the target tyre is safely picked up (for example, the handling of the robot and the positioning of the gripper 108 as shown in FIGS. 4 and 5), the arrangement of the tyres arranged in the group must be detected and the ideal target tyre for picking up must be identified. The detection data thus refers to a plurality of records representing the locations of at least one tyre or part of a tyre tracked over time. For example, the detection data can include one or more positions among the records of the positions of a reference point on part of the tyre (for example, the sidewall) over time or at defined time intervals; sensor data taken over time; a video stream that has been processed using a computer vision technique; and/or data indicating the operating status of the device 100 over time. In some cases, the detection data can include data representing one or more continuous movements of the picking device before it stops to take one or more images of the arranged tyres. The detection system of the device 100 is therefore configured to generate the movement data of the device.

In some embodiments of the invention, the detection system of the device 100 can also comprise a movement capture device selected from infrared sensors, ultrasonic sensors, accelerometers, gyroscopes, pressure sensors, and/or other equivalent devices. By way of an example, a movement capture device of the system of the invention can comprise one or a pair of digital gloves for performing remote management movements of the device 100. In these embodiments, the system (and particularly the device 100) learns the movements made by the target tyre arrangement without operator intervention during one or more subsequent positioning processes that form part of the lacing method.

In order to implement the method of the invention by means of a computer, the lacing system of the invention comprises a communication network (or “network”) that manages the data entering the system from various sources (for example, from at least one device 100 and the associated detection system thereof). The communication network incorporates one or more communication servers (or “servers”) each comprising one or more processors operationally connected to a memory. The memory is configured to store an application for analysing data representing imaged tyres. The one or more processors comprise a module for executing the analysis application (or “image processing module”) that processes the images, with the one or more processors being capable of executing programmed instructions stored in the memory in order to perform the steps of the lacing method (as described below).

With reference to the device 100, the initial positioning thereof (and, where applicable, the initial orientation of the gripper 108) is determined from data obtained by acquiring images of the lacing system and of the physical environment in which the lacing system operates. A module for executing the analysis application of the processor uses an automatic and adaptive repositioning algorithm to find an ideal starting position for the device 100, therefore allowing programmed instructions stored in the memory to be executed in order to pick up a first identified target tyre to be positioned in a predetermined target location (for example, a trailer 300). The repositioning algorithm allows continuous improvement across all the tyre picking operations, ensuring that the lacing system (and particularly the device 100) improves from the experience it acquires, notably regarding the selection of the tyres to be extracted from the first identified tyre for the lacing.

The term “processor” (or, alternatively, the term “programmable logic circuit”) denotes one or more devices capable of processing and analysing data and comprising one or more software packages for processing said data (for example, one or more integrated circuits known to a person skilled in the art as being included in a computer, one or more controllers, one or more microcontrollers, one or more microcomputers, one or more programmable logic controllers (PLCs), one or more application-specific integrated circuits, one or more neural networks, and/or one or more other known equivalent programmable circuits). The processor comprises one or more software packages for processing the data captured by the detection system of the device 100 (and the corresponding obtained data), as well as one or more software packages for identifying and locating variances and for identifying their sources in order to correct them.

In the system of the invention, the memory can comprise both volatile and non-volatile memory devices. The non-volatile memory can comprise solid-state memories, such as the NAND flash memory and the keep-alive memory (or KAM) for saving various operating variables while the processor is switched off, magnetic and optical storage media, or any other suitable data storage device that retains the data when the device 100 is deactivated or has lost its power supply. The volatile memory can comprise a static and dynamic RAM that stores program instructions and data, including a learning application.

In some embodiments of the system of the invention, the processor can configure the device (and notably the gripper 108) on one or more parameters of the identified tyre computed by an image processing module incorporated into the memory of the processor.

In some embodiments of the lacing method of the invention, the processor can configure the lacing system (and notably the device 100) on one or more parameters of a target tyre computed by an image processing module. In these embodiments, it is understood that one or more reinforcement learning means could be used. A person skilled in the art in this field will acknowledge that there are numerous image processing techniques that can be used in order to select and to determine the parameters of the target tyres. There are several commercially available image processing systems that can be used.

In order to implement the method of the invention by means of a computer, the system of the invention comprises a communication network (or “network”) that manages the data entering the system from various sources (for example, from at least one device 100 and the associated detection system thereof). The communication network incorporates one or more communication servers (or “servers”) each comprising one or more processors operationally connected to a memory. The memory is configured to store an application for analysing data representing the positions of the imaged tyres. The one or more processors comprise a module for executing the analysis application that processes the images, with the one or more processors being capable of executing programmed instructions stored in the memory so as to carry out the steps of the method (as described below).

The data entering the lacing system of the invention can include the general information relating to the identified tyre. The general information includes the stored data regarding the identification of the identified tyre (including, but not limited to, its production site, its distribution and/or storage, its production date, its retreading history, if applicable, and its fitting position and history). The corresponding data could be collected by one or more known devices (for example, an RFID device disposed in or on the identified tyre).

The processor can also refer to a reference (for example, a look-up table of various tyre sizes) in order to make a final determination of one or more parameters of the identified tyre. The reference can include known tyre parameters corresponding to a plurality of commercially available known tyres. For example, after the image processing module has computed one or more identified tyre parameters, the processor can compare the computed parameters with the known parameters recorded in the reference. The processor can retrieve the parameters of known tyres corresponding to the commercially available tyres that most closely match the computed parameters in order to configure the gripper 108 (and therefore place it in a precise position in order to pick up and position the identified tyre). The reference of tyres can include measurements corresponding to a plurality of commercially available tyres. By way of an example, for a tyre of size 225/50R17, the number “225” identifies the cross section of the tyre in millimetres, the number “50” indicates the aspect ratio of the sidewall, and the measurement “R17” represents the diameter of the rim in inches (which is approximately 43.18 centimetres).

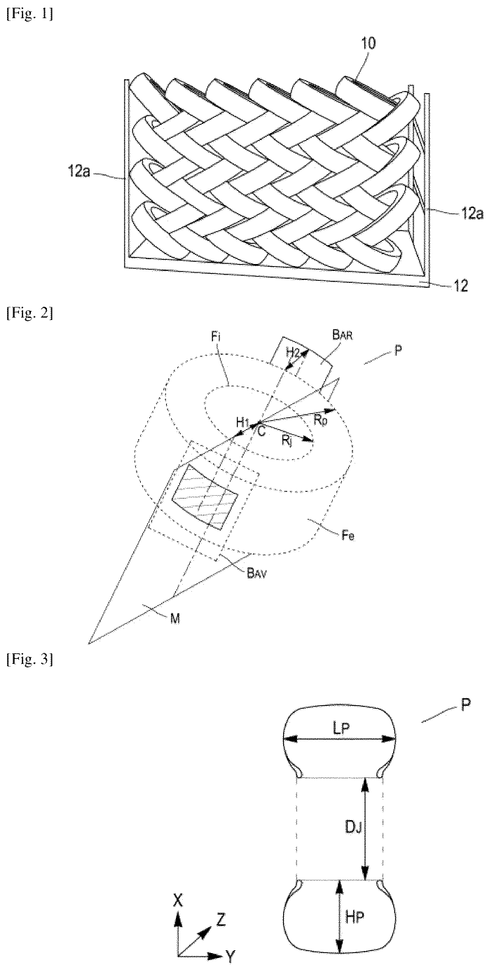

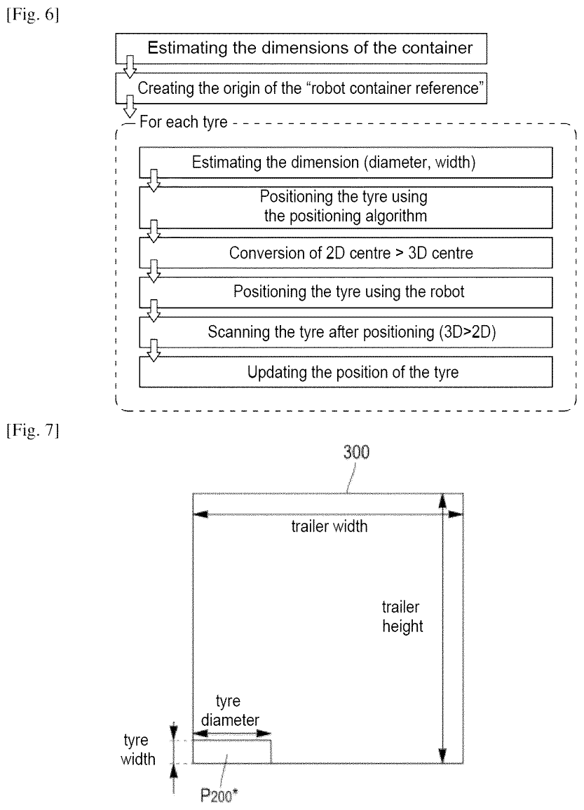

With further reference to FIGS. 1 to 5 and also to FIGS. 6 to 19, a detailed description is provided, by way of an example, of the embodiments of a lacing method (or “method”) of the invention allowing tyres to be laced in a target location (for example, inside a trailer 300 of a truck) (see FIG. 7). The lacing method is implemented by the system of the invention in any physical environment without prior knowledge of the dimensions of the tyres in the group of tyres intended for lacing and without prior knowledge of their arrangement. Therefore, it is understood that the location positions of the tyres are generated extemporaneously to allow the various dimensions of the successive tyres to be taken into account according to the parameters of the target location.

As used herein, the term “method” or “process” can include one or more steps performed by at least one computer system comprising one or more processors for executing instructions that complete the steps (for example, the steps of a positioning algorithm implemented by the system of the invention). Unless otherwise indicated, any sequence of steps is provided by way of an example, and does not limit the described methods to any particular sequence.

In performing the lacing method of the invention, the system of the invention incorporates a combination of vision and machine learning techniques in order to correctly and quickly reconstruct the observed scene based on three-dimensional (or “3D”) dispersed point clouds originating from a view of the tyre identified for lacing. The system of the invention therefore continuously improves the recognition of the various tyres and their relative positioning relative to the target location.

FIG. 6 shows a flow diagram of an embodiment of the operation of the system of the invention during a lacing method performed by the system. As shown in FIG. 6, the “simulator” represents a positioning algorithm implemented by the system of the invention for selecting the optimal location of a tyre to be laced.

The positioning algorithm (or “simulator”) implemented by the system of the invention can be considered to be a physical model seeking to represent the physics associated with lacing the tyre in a predetermined target location. As other models, it has assumptions:
The workspace and the tyres are shown in a two-dimensional (“2D”) space. Each tyre is shown by a rectangle (the width of the rectangle represents the width of the tyre casing and the height of the rectangle represents its diameter) that will be positioned in a larger rectangle representing the group of tyres being laced (see FIG. 7).
The positioning algorithm does not lace the tyres, but it searches for positions that promote their lacing. The interaction with a detection system of the lacing system allows the lacing of the tyres to be taken into account in the positioning algorithm.
It is assumed that there is no slippage between the different tyres when constructing a stacked group of tyres. Thus, the packing-down phenomenon of the tyres is not taken into account.
The positioning algorithm is based on rules implemented to position each tyre (for example, the orientation of the casings, the concept of “rows”, etc.).

It is obvious that this physical model could be refined to improve the performance capabilities. By way of an example:
The positioning algorithm could be improved by working in a three-dimensional space, representing each tyre in a three-dimensional (3D) shape (for example, a shape derived from a CAD model).
The lacing of the tyres could be taken into account by the positioning algorithm by allowing the tyres shown in 3D to be nested.
The slippage and packing-down of the tyres could be integrated.
The rules implemented to position each tyre could be replaced by a reinforcement learning algorithm that would seek to learn the most relevant rules by itself. This would allow the obtained lacing density to be increased.

With further reference to FIGS. 6 and 7, by initiating the lacing method of the invention, the method comprises a step of estimating the dimensions of a target location where the tyres are intended to be laced.

By way of an example, throughout the remainder of the description, the trailer 300 of FIG. 7 is referred to as the target location that is the object of this estimate. It is understood that the target location could selected from among one or more known target locations for achieving the lacing and for transporting tyres (including, but not limited to, containers, pallets, open-bodies of trucks, chain-bound beds of trucks, box-bodies of trucks or vans and equivalents thereof).

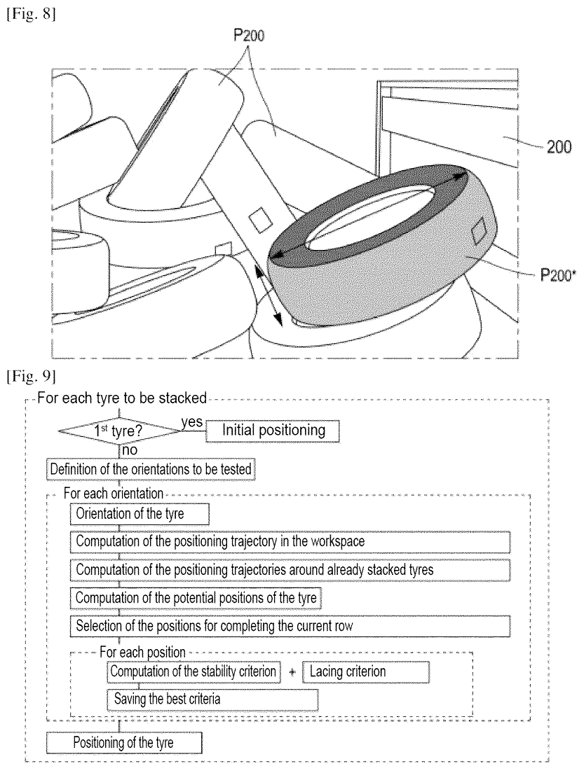

The step of estimating the lacing method comprises a step of scanning the inside of the target location where the tyres are intended to be laced. During this step, the lacing system uses its detection system to scan the inside of the target location and to estimate its parameters (i.e., its dimensions). Taking the example of the trailer 300 of FIG. 7, during this step, the detection system scans the inside of the trailer to determine its length, its width and its depth. The lacing method further comprises a step of creating the origin of a location-device reference. During this step, to start lacing tyres, it is necessary to know where to begin placing the first tyre in the target location based on the parameters obtained during the step of scanning the inside of the target location (for example, it is necessary to know where to begin placing the tyre P_{200*} in the trailer 300 that originates from a group of tyres P₂₀₀ stored in a container 200) (see FIG. 8). By way of an example, for the remainder of the description, a reference is placed at the coordinates that correspond to the lower left-hand corner of the trailer 300 (located at the bottom of the trailer 300). This reference will allow the device 100 to be controlled so that it positions the tyres in the trailer 300. If the reference is placed in another corner, the complete system would operate with some adaptations.

The lacing method further comprises a step of estimating the dimensions (the diameter and the width) of a target tyre to be laced in the predetermined target location (see the tyre P_{200*} of FIG. 8). During the estimation step, the detection system is used to identify the first tyre to be taken from among several tyres arranged in an unknown arrangement (for example, the group of tyres P₂₀₀). It is understood that a known system for supplying tyres to be loaded could be used to bring the tyres to the device 100 (for example, a system incorporating one or more belts for transporting the tyres to the device 100 and its detection system). The diameter and the width of the tyre P_{200*} are shown in an initial position in FIG. 7 (with the initial position being defined according to the location-device reference created during the step of creating the origin of the reference).

In one embodiment of a lacing method implemented by the lacing system incorporating the device 100 (and/or an equivalent device), the system of the invention performs a learning process on the basis of a single example or a small number of examples (known as “few-shot learning” or “FSL”). Few-shot learning can reduce the data collection load for data-intensive applications (notably image classification and video event detection), helping to alleviate the burden of large-scale supervised data collection (see “One-Shot Learning of Object Categories”, Fei-Fei, Li, Fergus, Rob and Perona Pietro, IEEE Transactions on Pattern Analysis and Machine Intelligence, Vol. 28, Issue 4, pages 594-611 (April 2006) (https://doi.org/10.1109/TPAMI.2006.79). This process is performed as disclosed in application FR 2113035 of the Applicant. In one embodiment of the lacing method for the device 100, the system uses few-shot learning to facilitate a storage optimisation function aimed at optimising the gripping of tyres. The system of the invention therefore implements continuous improvement with respect to the selection of the tyres to be picked.

In this embodiment of the lacing method performed by the lacing system incorporating the device 100, the few-shot learning process uses an attention mechanism to pick target tyres.

The few-shot learning process benefits from a neural network structure allowing it to focus only on tyres that are suitable for being picked by immediately recognising them. This makes the device 100 (and therefore the system of the invention) faster and more reliable since it knows how to adapt to all the tyre orientations it sees. In addition, the adaptation to the tyre arrangements is achieved irrespective of the configuration of the picking device of the management system.

In this embodiment of the lacing method, the few-shot learning process comprises a step of acquiring data corresponding to the arranged tyres. In the group of tyres intended for lacing in the target location, during this step, the detection system (for example, an RGB-D camera 400 of the lacing system of the invention and/or of the device 100) (see FIG. 5) captures an initial image of a group of tyres P₂₀₀ randomly arranged in an unknown location (for example, a container 200, as shown in FIGS. 5 and 8). In this example, several overlapping tyres appear in the field of view of the detection system. During this step, a point cloud is constructed from RGB-D images as described above.

The few-shot learning process also comprises a step of feeding an extraction neural network (or “extraction network”) and an attention neural network (or “attention network”). This step comprises a step of training the extraction network to segment the scene viewed by the detection system. In one embodiment of the method, this step can comprise a step of segmenting the data based on a plurality of cycles of a repetitive movement of the picking device during one or more lacing cycles. The segmentation performed during this step differentiates between an object in the image that includes a tyre (either a whole tyre or a partial tyre) and an object in the image that does not include any tyres.

During the feeding step, the extraction network and the attention network are trained by taking a plurality of sample images (obtained during the acquisition step) as training data and a plurality of classifications of objects in images (or “heat maps”) as data labels. By way of an example, based on the classification of objects in images, an image can be evaluated in order to determine whether the image is capable of attracting the attention of the detection system after the image comprising the tyre targeted for picking up is fed back to the detection system.

During this step, the RGB-D camera provides information relating to the depth of the arranged tyres.

The feeding step comprises a step of constructing an attention mechanism. During this step, the attention network extracts differentiated features from various categories in a target tyre detection model (or “model”), such that the model is guided to locate key areas with important features in a segmented image (i.e., an image incorporating the tyre most suitable for picking up). The model provides better monitoring in the key areas in order to learn any differences among easily confused categories (for example, the tyre most suitable for picking up among the arranged tyres on the basis of a labelled set of images). The accuracy of detecting the target tyre in the image is therefore improved so as to be able to select the target tyre identified for picking up.

In this embodiment of the lacing method, the process further comprises a step of performing a three-dimensional (3D) reconstruction process that is used to provide the geometric information required to generate the ideal pick-up point for the picking device (for example, picking up by a gripper 108 of a device 100). The 3D reconstruction process comprises a reconstruction process that is wholly performed on the basis of the data from the extraction and attention networks. During this step, the orientation, the dimensions and the location of the identified target tyre are reconstructed from this information data. In so doing, the management system (including the device 100) has recognised the arranged tyres (including their orientations and their positions) from examples of tyres during the few-shot learning process.

During this step, the management system constructs a virtual tyre in the form of a cylinder on the visible surface of the cluster representing a target tyre. During this step, the centre of the identified target tyre is identified in order to estimate its inner and outer diameters (with the inner diameter being represented by twice the rim radius R_{J}, as discussed above with reference to FIG. 2). Once the attention network learns the location of the target tyre and its orientation, it sends the corresponding coordinates (for example, the X, Y, Z coordinates and the orientation of the tyre axis) to the device 100. At this stage of the process, routing plans and distance conversions are already made in order to extract the identified target tyre. Thus, the management system has dictated the expected information fed back from the detection system (namely the RGB-D camera). Consequently, the device 100 applies the movements needed to pick up and release the target tyre at the ideal pick-up point.

The lacing method of the invention further comprises a step of performing a positioning process for each tyre to be laced. This step comprises a step of approaching the device 100 towards the identified target tyre during the data acquisition step (for example, the target tyre P_{200*} shown in FIG. 8). This step further comprises a step of picking up the identified target tyre at the ideal pick-up point during the data acquisition step (for example, as computed during the step of performing the 3D reconstruction process). For the configuration of a device 100 as shown in FIGS. 4 and 5, during this step, the gripper 108 is managed so that it engages a sidewall of the target tyre (for example, by extending one or more fingers of the gripper towards a pick-up point of the inner boundary F_{I} of the sidewall F) (see FIG. 2). It will be clearly understood that the implementation of the method of the invention is not limited by the configuration of the gripper device 108 of the device 100.

During the step of positioning the identified target tyre for picking up, the positioning algorithm implemented by the processor of the lacing system only considers the group of tyres being laced. This group is modelled in a two-dimensional (2D) space in the form of a rectangle. The width and the height of the rectangle are equal to the width and the height of the inside of the target location (for example, the width and the height of the trailer 300). The purpose of the positioning algorithm then involves positioning the successive tyres in this rectangle. Each tyre is also modelled using a rectangle, the width and the height of which are equal to the width and the diameter of the depicted tyre.

Reference will now be made to FIG. 9, which shows a tyre positioning process performed during the positioning step. The tyre positioning process comprises a step of positioning the first tyre that is grippable, with this tyre being the “target tyre”. This first tyre is positioned flat in a location corresponding to the selection of the location-device reference (created during the step of creating the origin of the reference). By way of an example, this first tyre is positioned in the lower left-hand corner of the trailer 300 (with this behaviour being related to the previous selection of the location-device reference) (see FIG. 7).

The tyre positioning process further comprises a step of storing tyres from the second tyre.

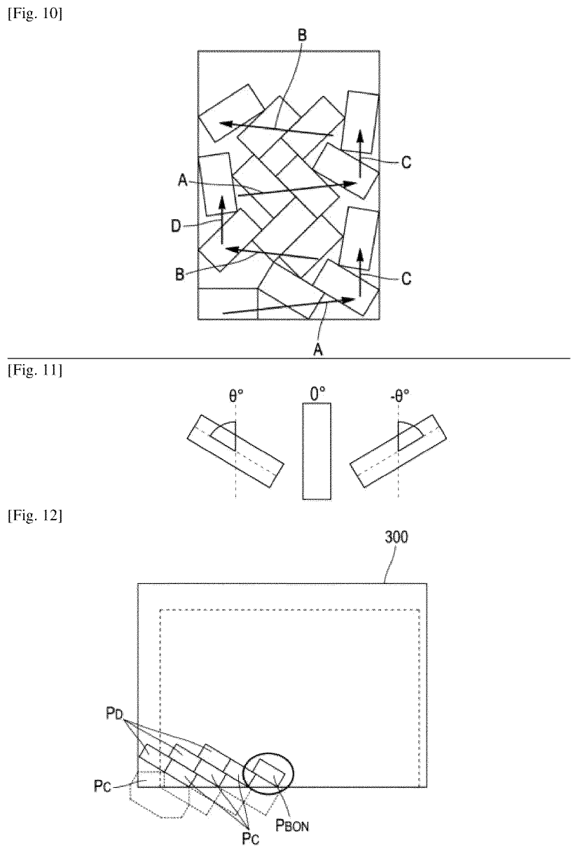

During this step, the positioning algorithm uses a concept of rows that is a series of tyres positioned in the same direction. With reference to FIG. 10, four (4) types of directions are distinguished, comprising:
to the right (shown by the arrows A of FIG. 10);
to the left (shown by the arrows B of FIG. 10);
upwards following a row to the right (shown by the arrows C of FIG. 10); and
upwards following a row to the left (shown by the arrow D of FIG. 10).

During the step of storing tyres, the lacing system starts by filling a row according to the starting point (which could be “to the right” as shown by the arrows A or “to the left” as shown by the arrows B) (see FIG. 10). Each type of row is associated with an orientation set to be tested for the tyre to be positioned (see FIG. 11). The lacing system therefore begins by orienting the tyre according to the first orientation value to be tested (for example, the orientation shown by the angle Θ or the orientation shown by the angle—Θ in FIG. 11).

With reference to FIG. 12, an example is provided of achieving a row of tyres in a target location (in this case, the trailer 300, which is also shown in FIG. 7). During the step of storing tyres, the positioning algorithm applies the following steps in order to select the candidate positions of the tyre:
a step of initially computing all the positions that bring the relevant tyre into contact with the boundaries of the target location;
a step of subsequently computing all the positions that bring the tyre into contact with the other already laced tyres (shown in FIG. 12 by the tyres P_{C});
a step of retaining, from among all the positions computed during the previous step, positions allowing the tyre to have at least two contact points with the boundaries of the target location or with the other tyres (shown in FIG. 12 by the tyres P_{D}); and
a final step of retaining positions for completing the current row (shown in FIG. 12, by way of an example, by the encircled tyre P_{BON} that depicts the only position for completing the current row) (in this case, “to the right”).

It is understood that the steps of positioning the encircled P_{BON} tyre could be different depending on the parameters of the target location (for example, the height, the width, and the depth of the trailer 300). Furthermore, the relative dimensions of the tyre in the group of tyres must be taken into account to select the candidate positions of the tyre (these dimensions are assumed to be equal for all the tyres being laced).

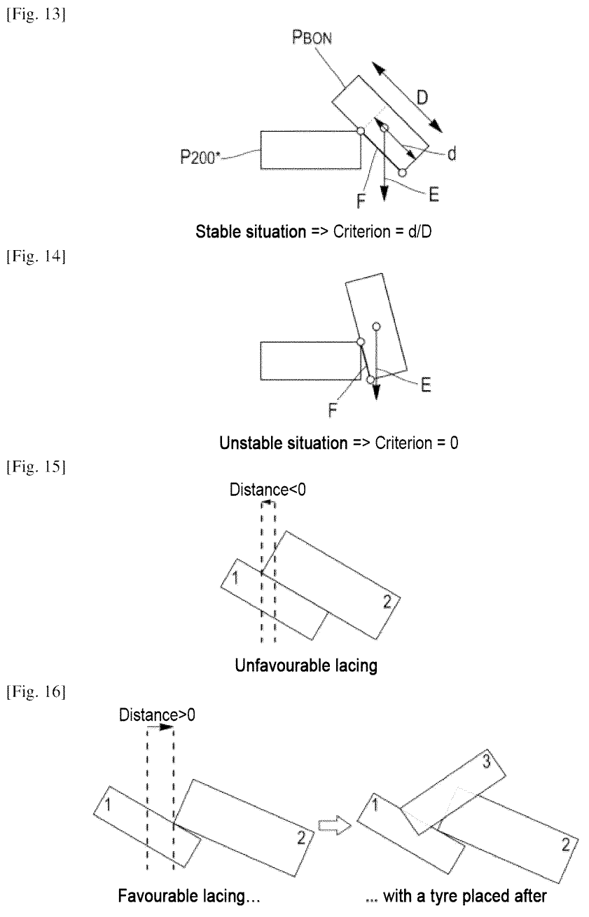

The step of storing tyres further comprises a step of computing a stability and lacing criterion. The stability criterion is used to determine whether the position of the tyre is stable at each position retained following the selection of the candidate positions of the tyre. With reference to FIGS. 13 and 14, the tyre P_{200*} represents a tyre that is already positioned, and the tyre P_{BON} represents a tyre to be positioned (it is understood that the precise positions of the tyres P_{200*} and P_{BON} are provided by way of an example and that other positions could be assumed). The stability of the position of the new tyre depends on the vertical starting from its centre of gravity (see the arrow E in FIGS. 13 and 14) and the bearing area of the new tyre (see the area F shown in FIGS. 13 and 14). If the vertical does not pass through the bearing area, the position is unstable (see FIG. 14). Otherwise, the position is stable and the stability of the position can be estimated by dividing the length of the bearing area F by the diameter of the tyre (with this estimation being the “stability criterion”) (see FIG. 13). In this case, the position is maintained if its stability is strictly greater than 0.5.

It is understood that one or more embodiments could integrate slippage between the tyres in the stability criterion to improve the physics of the model.

The lacing criterion is based on the horizontal signed distance between the centre of the last placed tyre and the end of the new tyre. Only the positions that are far enough from the last tyre are retained. If several positions are retained, the final position of the new tyre will be the one closest to the last positioned tyre (to avoid forming excessively large spacings, or “holes”, between two successive tyres). Conversely, if no position is retained, this means that the end of the row has been reached and the next row needs to be started. The system therefore transitions to the next row, and it again applies the preceding steps in order to find the best position for the new tyre.

With reference to FIGS. 15 and 16, an illustration of the lacing criterion is provided that relies on the horizontal signed distance between the centre of the last placed tyre (see the tyre 1) and the end of the new tyre 2. In FIG. 15, the new tyre 2 covers the centre of the last tyre 1, which results in a negative distance and an unfavourable lacing situation (the hollow area of the last tyre that could accommodate a portion of a future placed tyre is covered). In FIG. 16, the new tyre 2 is far enough away from the last tyre 1 to cause a favourable lacing situation (resulting in a positive distance). By way of an example, another tyre 3 that is placed afterwards may enter the hollow portion of the tyre 1, and lacing of the tyres is also achieved.

It is understood that one or more embodiments could integrate penetration between the tyres in the lacing criterion to improve the physics of the model.

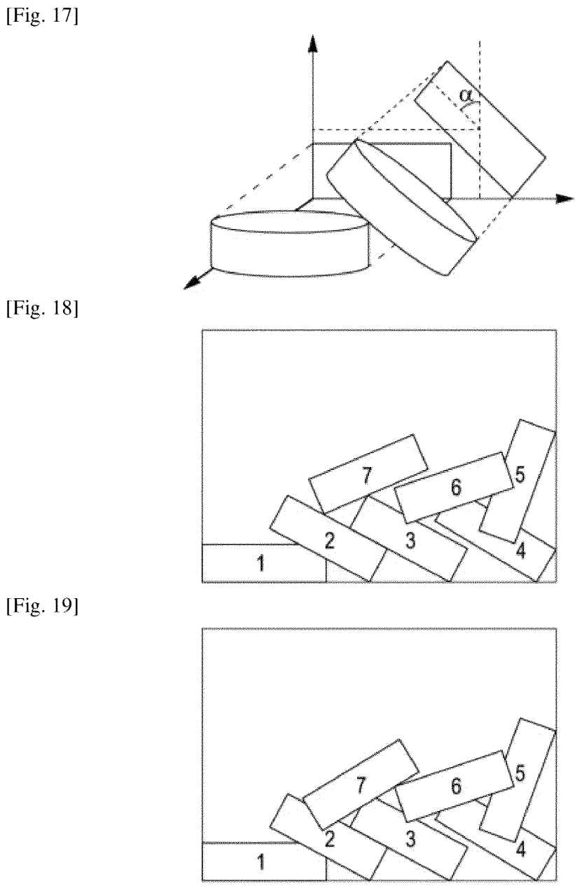

The step of storing the tyre further comprises a conversion step. During this step, the 2D centre of the tyre derived from the positioning algorithm is converted towards the 3D centre of the tyre in the predetermined target location. With reference to FIG. 17, the positioning algorithm indicates the centre of the tyre in the rear plane of the group of tyres (shown in FIG. 17 by the dashed segments), as well as its orientation (shown in FIG. 17 by the angle α). To position the tyre in the target location (for example, the trailer 300), its position in the 3D coordinate system of the target location needs to be known (defined as a function of the location-device reference created during the step of creating the origin of the reference). To this end, the 2D centre is shifted forwards by a value equal to the radius of the tyre (for example, the radius R_{P}) (see FIG. 2). The 3D centre of the tyre is thus obtained and coupled with the orientation (angle α) retained for positioning the tyre in the target location.

The lacing method of the invention further comprises a step of scanning the tyre in place after it has been positioned (performed during the preceding step). During this step, the positioning algorithm uses a lacing criterion to select the position of the tyre, but it does not lace the tyres (it does not manage the penetration of the tyres in one another). The lacing of the tyres is naturally achieved when the gripper of the device 100 releases the tyre. Therefore, it should be understood that the positioning algorithm computes a “position before lacing”. During this step, this “position before lacing” needs to be updated to become a “position after lacing” that is the actual position of the tyre in the predetermined target location (for example, the trailer 300). This is necessary in order to correctly position the next tyres in the target location.

Without this update, there would be a drift or a deviation between the “positions before lacing” of the positioning algorithm and the actual positions of the tyres in the target location. In order to know this actual position, the lacing system incorporates a combination of vision and machine learning techniques in order to correctly and quickly reconstruct the observed scene based on 3D dispersed point clouds originating from a view of a group of stacked tyres. The system thus implements continuous improvement in terms of the recognition of the tyres and their relative positioning along the inner surface of the target location (for example, the trailer 300).

During the step of scanning the tyre, the lacing system uses its detection system to scan an area where the last tyre has been positioned. During this step, the attention mechanism (described above) is then used to detect the last tyre positioned in the colour image.

In one embodiment, a reference can be created that incorporates the coordinates of the centres of the tyres that are sought in images captured by the detection system of the device 100 (for example, an RGB type camera). The coordinate reference that is created during this step comprises expected images corresponding to the distributed centres in the target location. The images obtained during the scanning step that reveal one or more positions of the centres of the tyres intended for lacing cause at least one neural network to identify all the expected positions of the centres in the imaged target location. Thus, these image variations are used as input for the neural network, which outputs the classification of the coordinates of the centres of the tyres. In this embodiment of the method, at least part of the reference of the centres can be created by one or more persons skilled in the art.

Since the 3D points of this tyre are recovered, a cylinder at these 3D points is then adjusted. The 3D points of the cylinder are projected in the rear plane of the group of tyres for obtaining a set of 2D points. In embodiments of the method, during this step, a neural network can be trained in order to recognise the actual coordinates of the centres and to create bounding boxes (or “boxed regions”) around the recognised centres. During this training, the coordinates of the bounding box of the recognised centre are correlated with the coordinates of the sought after centres in order to compute any displacements between them. The boxed regions and the displacement computations are transmitted to a neural network (for example, one or more CNNs) in order to jointly learn the representation of a tyre in various perspectives of the images taken by the detection system of the device 100. Thus, the bounding box of these 2D points provides the actual centre and the actual orientation of the tyre to be transmitted to the positioning algorithm in order to update it.

Reference will now be made to FIGS. 18 and 19, the lacing method of the invention further comprises a last step of updating the position of the tyre. By virtue of the scan performed during the step of scanning the positioned tyre, the actual position of the last positioned tyre has been estimated (see FIG. 18 where the tyre 7 is not laced with respect to the tyres 1 to 6). This position comprises the 2D centre of the tyre as well as its orientation. By changing the values of the 2D centre and the orientation with those estimated during the scan, the positioning algorithm is updated with the actual position of the last positioned tyre. By displaying the actual positions after this update, it has been found that the tyres are properly laced (see FIG. 19 where the tyre 7 is properly laced after updating the positions of the tyres 1 to 6).

This updating step also allows the actual position estimated in the preceding step to be checked to determine that it is consistent with the positions of the other tyres (ensuring that the overlap between the last tyre (for example, the tyre 7 of FIGS. 18 and 19) and the other tyres (for example, the tyres 1 to 6 of FIGS. 18 and 19) is not too great). Furthermore, this updating step allows the actual position estimated in the preceding step to be checked to determine that it is consistent with the physical boundaries of the target location (ensuring that the actual position of the last tyre (for example, the tyre 7 of FIGS. 18 and 19) is inside the target location (for example, the inside of the trailer 300). This step therefore improves the reliability of the complete system by allowing it to detect some inconsistencies.

The lacing system of the invention can easily repeat the steps of the lacing method in a sequence for properly lacing the tyres of a group in an arrangement that is suitable for the parameters of the target location.

In all the embodiments of a lacing method performed by the lacing system incorporating at least one device 100, the steps can be performed simultaneously on all the arranged tyres by means of a parallelisation performed by the processor that is used.

In a management facility incorporating the lacing system, the data gathered by the sensors can be used for managing an apparatus that picks up the tyres arranged in the target location. In one embodiment of the management facility, this apparatus comprises at least one device 100 of the type described above and shown in FIGS. 4 and 5.

In one embodiment, the sensors can comprise one or more detection sensors (not shown) that detect the presence of one or more tyres as a function of the properties of the target location (for example, the height and/or the width and/or the depth of the trailer 300). The detection sensors can be selected from among commercially available sensors (for example, sensors of the reflector type). The detection of a first tyre at the defined reference in the loading space can trigger the lacing method performed by the lacing system.

In one embodiment of the system, the sensors can comprise one or more detection sensors (not shown) that detect the presence of one or more tyres as a function of the properties of the target location (for example, the height and/or the width and/or the depth of the trailer 300).

The detection sensors can be selected from among commercially available sensors (for example, sensors of the reflector type). The detection of a first tyre at the defined reference in the loading space can trigger the lacing method performed by the lacing system.

In a tyre management facility incorporating the lacing system of the invention, a detection system can be used to detect the presence of a tyre arrangement in the field of view of a camera of the detection system (for example, the camera 400), which triggers the camera to capture the image of one or more tyres. In instances in which part of the tyre is not visible in the image obtained by the camera, an arbitrary point can be placed in a known position with respect to the sensor of the detection system (for example, at a known horizontal distance and at a known vertical distance from the position of the sensor).

The sensors of the target location, the sensors of the device 100 and the vision system of the management facility therefore can provide information concerning the physical environment that can be used by a control system (which comprises, for example, software for planning tyre lacing and/or software for controlling the corresponding movements of the device 100).

The control system could communicate remotely. In some embodiments, one or more sensors mounted on the device 100 (including, non-limitingly, navigation sensors) can be integrated in order to form a digital model of the physical environment (including, where applicable, the side or sides, the floor and the ceiling). Using the obtained data, the control system can cause the device 100 to move in order to navigate between the positions for lacing the target tyres as a function of the parameters of the target location.

In order to avoid a complex and slow approach that is difficult to maintain and evolve, the disclosed invention associates a positioning algorithm with a 3D vision system of the detection system in order to take into account the complexities of interactions between different tyres (including slippage and lacing). The significant advantage of this approach lies in associating the positioning algorithm with steps of scanning the tyre after positioning in order to take into account the complexities of interactions between different tyres (including slippage and lacing). Provision is made for the positioning algorithm that is used to operate without additional work on any type of tyre of any dimension. This avoids having to use a positioning algorithm based on a very in-depth physical model that would be more complex to use, maintain and evolve and would have longer computation times and therefore potentially would be incompatible with the requested cycle times. Accordingly, the invention allows tyres to be laced within a confined space, which presents a complex situation because collisions need to be managed with the internal boundaries of the space provided for lacing.

Before initiating the method of the invention, orders for particular tyres could be received by known means (for example, by one or more communication networks integrated into a facility incorporating the lacing system of the invention). The facility allows the orders to be received up to a specific time in order to ensure that the ordered tyres are laced “just in time” (when the lacing method starts).

A method of the invention can be performed under the control of the PLC and can include pre-programming of management information. For example, a setting of the method can be associated with the parameters of the provided target location and/or the properties of the tyres intended for lacing. The system of the invention (and/or a facility incorporating this system) can easily repeat one or more steps of the method in a given sequence in order to satisfactorily supply the ordered tyres to obtain desired lacing of the tyres.

The system of the invention (and/or a facility incorporating this system) can include pre-programmed management information. For example, a setting of the method can be associated with the parameters of the typical physical environments in which the system operates. In some embodiments of the invention, the system (and/or a facility incorporating this system) can receive voice commands or other audio data representing, for example, a command to start or stop the device 100 and/or lacing of one or more tyres in a group of identified tyres. The request can include a request for the current state of a lacing cycle. A generated response can be represented in an audible, visual or tactile manner (for example, using a haptic interface) and/or in a virtual and/or augmented manner. This response, associated with the corresponding data, can be recorded in a neural network.

A monitoring system could be implemented for all the embodiments of the system. At least part of the monitoring system can be provided in a portable device such as a mobile network device (for example, a mobile telephone, a laptop computer, one or more portable devices connected to the network (including “augmented reality” and/or “virtual reality” devices), wearable clothing connected to the network and/or any combinations and/or any equivalents thereof). It is conceivable for detection and comparison steps to be able to be performed iteratively.

The terms “at least one” and “one or more” are used interchangeably. Ranges presented as lying “between a and b” include the values “a” and “b”.

Although particular embodiments of the disclosed apparatus have been illustrated and described, it will be understood that various changes, additions and modifications can be made without departing from the spirit or the scope of the present disclosure. Consequently, no limitation should be imposed on the scope of the described invention, apart from those disclosed in the appended claims.

1.-14. (canceled)

15. A method for automatically lacing tires from a group of tires in an unknown arrangement and intended for lacing in a predetermined target location, the method being implemented by at least one processor comprising an image processing module that uses a positioning algorithm to select an optimal location of a target tire to be laced and the method comprising the following steps:
a step of providing a lacing system including the at least one processor, wherein the lacing system comprises at least one picking device that picks up a target tire from the group of tires;
a step of estimating dimensions of a target location intended for the tires of the group of tires for lacing, this step comprising a step of scanning the target location in order to determine parameters of the target location;
a step of creating an origin of a location-device reference, during which step the lacing system creates a reference in order to determine positioning coordinates of a first tire in the target location;
a step of estimating dimensions of the target tire to be laced in the target location, during which step the at least one picking device identifies the first tire to be taken from the group of tires;
a positioning step for positioning each tire to be laced, this step comprising the following steps:
a step of performing a tire positioning process that is performed for each tire to be laced;
a step of approaching the at least one picking device towards the identified target tire; and
a step of picking up the identified target tire;
a step of scanning the tire after the tire is positioned during the positioning step; and
a final step of updating the position of the tire, during which step an actual position of a last-positioned tire, estimated during the step of scanning the positioned tire, includes a 2D center of the positioned tire and an orientation of the positioned tire, thereby updating the positioning algorithm,
wherein the updating allows the estimated actual position to be checked to determine that the estimated actual position is consistent with physical boundaries of the target location, and
wherein the lacing of the tires is achieved when the at least one picking device releases the tire.

16. The method according to claim 15, wherein, during the step of performing a positioning process for each tire to be laced:
the group of tires is modelled in a two-dimensional space in a form of a rectangle, wherein a width and a height of the rectangle are equal to a width and a height of an inside of the target location; and
each tire of the group of tires is modelled using a rectangle, a width and a height of which are equal to a width and a diameter of a depicted tire.

17. The method according to claim 15, wherein the step of estimating the dimensions of a target tire to be laced comprises a few-shot learning process comprising the following steps:
a step of acquiring data corresponding to the arranged tires, during which step a detection system of the at least one picking device captures an initial image of randomly arranged tires;
a step of feeding an extraction neural network and an attention neural network, during which step both neural networks are trained by taking a plurality of sample images obtained during the data acquisition step as training data and a plurality of classifications of objects in images as data labels;
a step of performing a three-dimensional reconstruction process wholly performed based on the data from the extraction neural network and the attention neural network, during which step coordinates corresponding to a location of an identified target tire and an orientation thereof are reconstructed from the data, such that the reconstruction can be used to provide geometric information required to generate an ideal pick-up point on the identified target tire;
a step of approaching the at least one picking device towards the identified target tire, during which step the attention neural network sends the coordinates corresponding to the location of the identified target tire and the orientation thereof to the at least one picking device; and
a step of extracting the identified target tire from the arranged tires in order to place the identified target tire in the target location.

18. The method according to claim 17, wherein the step of feeding the extraction neural network and the attention neural network comprises the following steps:
a step of training the extraction neural network to segment a scene viewed by the detection system of a management system; and
a step of constructing the attention mechanism, during which step the attention neural network extracts differentiated features from among various categories in a target tire detection model, such that the target tire detection model is guided in order to locate key areas in a segmented image,
wherein the step of training the extraction neural network comprises a step of segmenting data based on a plurality of cycles of a repetitive movement of the at least one picking device during one or more lacing cycles.

19. The method according to claim 17, wherein, during the step of performing the three-dimensional reconstruction process, the orientation, the dimensions and the location of the identified target tire are reconstructed from the data from the extraction neural network and the attention neural network.

20. The method according to claim 18, wherein the step of acquiring data from the few-shot learning process comprises a step of constructing a point cloud from RGB-D images, and
wherein the approach step of the at least one picking device comprises a step of picking up the identified target tire at the ideal pick-up point computed during the step of performing the three dimensional reconstruction process.

21. The method according to claim 15, wherein the tire positioning process comprises the following steps:
a step of positioning the first tire that can be picked up from the group of tires where the first tire is positioned flat in a location corresponding to the selection of the location-device reference created during the step of creating the origin of the reference; and
a step of storing tires from the second tire, during which step the positioning algorithm uses a concept of rows that is a series of tires positioned in the same direction, and wherein each type of row is associated with an orientation set to be tested for the tire to be positioned.

22. The method according to claim 21, wherein, during the step of storing tires, the positioning algorithm applies the following steps in order to select candidate positions of the tire:
a step of initially computing all the positions that bring the relevant tire into contact with the boundaries of the target location;
a step of subsequently computing all the positions that bring the tire into contact with already-laced tires;
a step of retaining, from among all the positions computed during the previous step, positions allowing the tire to have at least two contact points with the boundaries of the group of tires or with already-laced tires; and
a final step of retaining positions for completing a current row that represents an only position for completing the current row.

23. The method according to claim 21, wherein the step of storing tires further comprises:
a step of computing a stability and lacing criterion for determining whether a position of the tire is stable at each position retained following selection of the candidate positions of the tire; and
a conversion step, during which step the two-dimensional center derived from the positioning algorithm is converted towards the three-dimensional center of the tire in the target location,
wherein the positioning algorithm indicates the center of the tire in a rear plane of the group of tires, as well as an orientation thereof to position the tire in the target location so as to obtain the three-dimensional center of the tire and couple the tire with the orientation.

24. The method according to claim 23, wherein, during the step of computing a stability and lacing criterion:
a stability of the position of the new tire depends on a vertical starting from a center of gravity and a bearing area of the new tire; and
the lacing criterion is based on a horizontal signed distance between a center of the last placed tire and an end of the new tire.

25. The method according to claim 18, wherein, during the step of scanning the tire performed during the positioning step:
the lacing system scans an area where the last tire has been positioned; and
an attention mechanism is then used to detect the last-positioned tire.

26. A system for automatically lacing tires from a group of tires in an unknown arrangement and for which a predetermined target location must be produced, the system comprising:
at least one picking device comprising a robot having a peripheral gripping component supported by a pivotable elongate arm and extending from the elongate arm to a free end, at which a gripper is arranged along a common longitudinal axis;
a detection system for collecting information concerning a physical environment around each picking device, the detection system comprising one or more sensors configured to detect two-dimensional and/or three-dimensional images; and
a communication network that manages the data entering the system from the at least one picking device, the communication network comprising at least one communication server that allows programmed instructions to be executed that are stored in a memory of one or more processors of the system that uses a positioning algorithm in order to implement the method according to claim 15,
wherein each cleaning device is configured on one or more parameters of at least one identified tire computed by an image processing module incorporated into the memory of the one or more processors in order to set the cleaning device in motion so that the peripheral gripping component can pick up a target tire during the method performed by the system.

27. The system according to claim 26, wherein the detection system comprises at least one RGB-D camera fixed to at least one element from among the peripheral gripping component, the elongate arm and the gripper of the cleaning device.

28. The system according to claim 26, wherein the predetermined target location comprises at least one location selected from one or more containers, one or more trucks, one or more trailers, one or more warehouses, one or more distribution centers, one or more conveyors, one or more pallets, and one or more storage means.
